(19) United States
(12) Patent Application Publication
(10) Pub. No.: US 2026/0038980 A1
(43) Pub. Date: Feb. 5, 2026

(54) RECHARGEABLE BATTERY AND ELECTRODE PLATE THEREOF

(71) Applicant: SAMSUNG SDI CO., LTD., Yongin-si (KR)

(72) Inventor: Yeohoon YOON, Yongin-si (KR)

(21) Appl. No.: 19/238,281

(22) Filed: Jun. 13, 2025

(30) Foreign Application Priority Data
Jul. 30, 2024 (KR) 10-2024-0101147

(51) Int. Cl. H01M 50/533

(52) U.S. Cl. CPC H01M 50/533

(57) ABSTRACT

A rechargeable battery may include an electrode assembly including a separation layer between a first electrode plate and a second electrode plate including an electrode substrate, the electrode substrate including a coated area with an active material layer, and having a second thickness, and an uncoated area at a boundary of the coated area in a width direction, and having a first thickness that is greater than the second thickness, and a case accommodating the electrode assembly.

### CROSS-REFERENCE TO RELATED APPLICATION

The present application claims priority to and the benefit of Korean Patent Application No. 10-2024-0101147, filed on Jul. 30, 2024, in the Korean Intellectual Property Office, the entire disclosure of which is incorporated herein by reference.

### BACKGROUND

### 1. Field

The present disclosure relates to a rechargeable battery, and an electrode plate thereof.

### 2. Description of the Related Art

A rechargeable battery is a battery that is repeatedly charged and discharged, unlike a primary battery. A small-capacity rechargeable battery is used in a portable small electronic device, such as a mobile phone, a laptop computer, and a camcorder. A large-capacity and high-density rechargeable battery is used for a power source or energy storage for driving a motor of a hybrid vehicle and an electric vehicle.

A rechargeable battery includes an electrode assembly for charging and discharging current, a case or pouch accommodating the electrode assembly and an electrolyte, and an electrode terminal connected to the electrode assembly and drawn out of the case or pouch. The electrode assembly may be formed in a jelly roll type formed by winding an electrode and a separator, or may be formed in a stack type formed by stacking an electrode and a separator.

As the application fields of lithium rechargeable batteries expand and their capacities increase, aspects for performance changes during operation are becoming more diverse. Recently, as the energy density of rechargeable batteries increases and interest in rapid charging grows, the safety of even utilization of electrode plates and the local temperature rise in the electrode plates are being discussed.

In general, the thickness of the electrode substrate forming the electrode plate is controlled, or an organic/inorganic composite material is used in the electrode substrate, to increase the energy density while securing resistance and thermal performance. However, optimization of the electrode substrate is suitable because process limitations or performance trade-offs exist.

Energy density may be secured by thinning the electrode substrate, but if a certain heat capacity is exceeded, electrochemical non-uniformity may occur, along with a local temperature that may occur near the anode tab.

### SUMMARY

The present disclosure provides a rechargeable battery capable of resolving electrochemical non-uniformity, and capable of decreasing a local temperature rise by decreasing electrical resistance at an end portion of an electrode plate. The present disclosure provides an electrode plate of rechargeable battery capable of resolving the electrochemical non-uniformity, and capable of decreasing a local temperature rise by decreasing electrical resistance at an end portion.

A rechargeable battery may include an electrode assembly including a separation layer between a first electrode plate and a second electrode plate including an electrode substrate, the electrode substrate including a coated area with an active material layer, and having a second thickness, and an uncoated area at a boundary of the coated area in a width direction, and having a first thickness that is greater than the second thickness, and a case accommodating the electrode assembly.

The second thickness of the electrode substrate may have a twenty-first thickness at a first end of the coated area in the width direction, and gradually increases toward the uncoated area to have a twenty-second thickness at a second end of the coated area in the width direction.

The first thickness may have an eleventh thickness equal to the twenty-second thickness at the second end of the coated area, and gradually increases away from the coated area to have a twelfth thickness at a first end of the uncoated area in the width direction.

A thickness of the electrode substrate may increase linearly from the second thickness to the first thickness.

The active material layer may have a maximum thickness at the first end of the coated area, and gradually decreases toward the uncoated area.

The rechargeable battery may further include a current-collecting plate connected to the uncoated area.

The first thickness may be greater than the twenty-second thickness at the second end of the coated area, and is substantially constant across an entirety of the uncoated area in the width direction.

The first thickness may transition to the second thickness through a stepped line.

The active material layer may have a maximum thickness at the first end of the coated area, and gradually decreases toward the uncoated area.

The second thickness may be substantially constant across an entirety of the coated area in the width direction.

The first thickness may be substantially constant across an entirety of the uncoated area in the width direction.

The first thickness may transition to the second thickness through a stepped line.

The active material layer may have a same thickness across an entirety of the coated area in the width direction.

The first thickness may be substantially constant across an entirety of the uncoated area in a length direction.

The uncoated area may include a thick film portion and a thin film portion alternating along a length direction of the uncoated area.

The rechargeable battery may further include a tab is connected to the thick film portion.

An electrode plate of a rechargeable battery may include an electrode substrate including a coated area having an active material layer, and having a second thickness, and an uncoated area at an outer boundary of the coated area in a width direction of the electrode substrate, and having a first thickness that is greater than the second thickness.

A thickness of the electrode substrate may increase linearly from the second thickness to the first thickness across the width direction.

The second thickness may increase linearly across the coated area in the width direction, wherein the first thickness transitions to the second thickness through a stepped line, and is substantially constant across an entirety of the uncoated area in the width direction.

The second thickness may be substantially constant across an entirety of the coated area in the width direction, wherein the first thickness transitions to the coated area through a stepped line, and has a same magnitude across an entirety of the uncoated area in the width direction.

As such, according to one or more embodiments, electrode substrates of first and second electrode plates are formed of a coated area and an uncoated area, in which a first thickness of the electrode substrate in the uncoated area may be greater than a second thickness of the electrode substrate in the coated area, and the electrical resistance at the end portion of the electrode plate may be decreased. At the end portion of the electrode plate, the electrochemical non-uniformity may be resolved, and the local temperature rise may be decreased.

### BRIEF DESCRIPTION OF THE DRAWINGS

FIG. 1 is a cross-sectional perspective view of a rechargeable battery according to first one or more embodiments of the present disclosure.

FIG. 2 is a top plan view of an electrode plate applied to FIG. 1.

FIG. 3 is a cross-sectional view taken along the line III-III of FIG. 2.

FIG. 4 is a cross-sectional view of an electrode plate applied to a rechargeable battery according to second one or more embodiments of the present disclosure.

FIG. 5 is a cross-sectional view of an electrode plate applied to a rechargeable battery according to third one or more embodiments of the present disclosure.

FIG. 6 is an exploded perspective view of a rechargeable battery according to fourth one or more embodiments of the present disclosure.

FIG. 7 is a top plan view of an electrode plate applied to FIG. 6.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

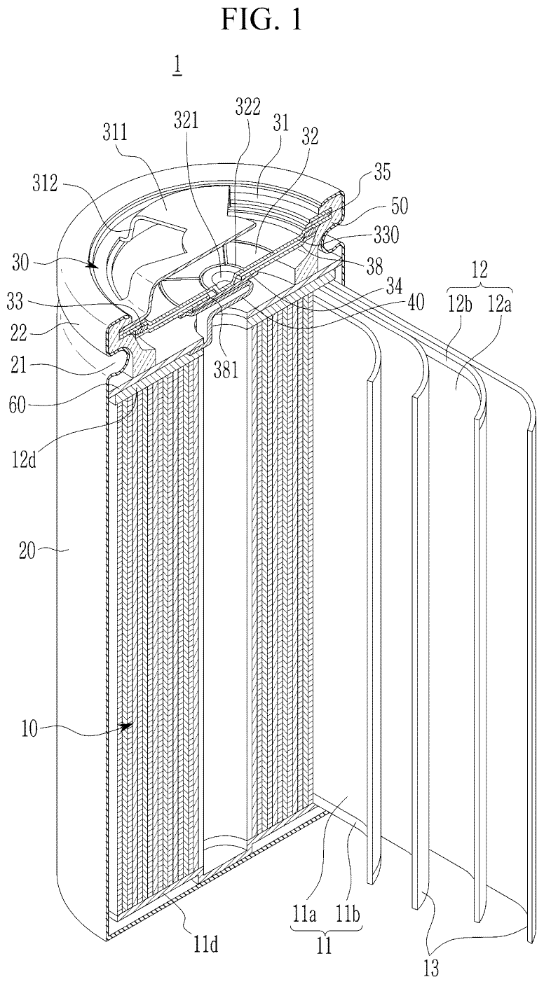

FIG. 1 is a cross-sectional perspective view of a rechargeable battery according to first one or more embodiments of the present disclosure. Referring to FIG. 1, a rechargeable battery 1 of the first one or more embodiments may include an electrode assembly 10 that functions to charge and discharge, a case 20, and a cap assembly 30.

The case 20 may house the electrode assembly 10, and may be electrically connected to a first electrode plate (e.g., negative electrode plate) 11 of the electrode assembly 10 through a negative current-collecting plate 11d. The cap assembly 30 may be coupled to an opening of the case 20 with a gasket 50 interposed therebetween, and may be electrically connected to a second electrode plate (e.g., positive electrode plate) 12 of the electrode assembly 10 through a positive current-collecting plate 12d.

As an example, the electrode assembly 10 may include the negative electrode plate 11, a separation layer 13, and the positive electrode plate 12 that are sequentially stacked. The electrode assembly 10 may be formed by winding the negative electrode plate 11, the positive electrode plate 12, and the separation layer 13, which is an insulator located therebetween, in the jelly-roll state. The electrode assembly 10 may be formed in a cylindrical form.

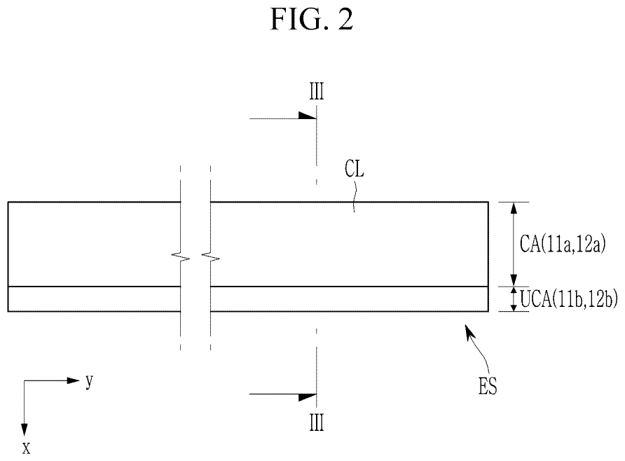

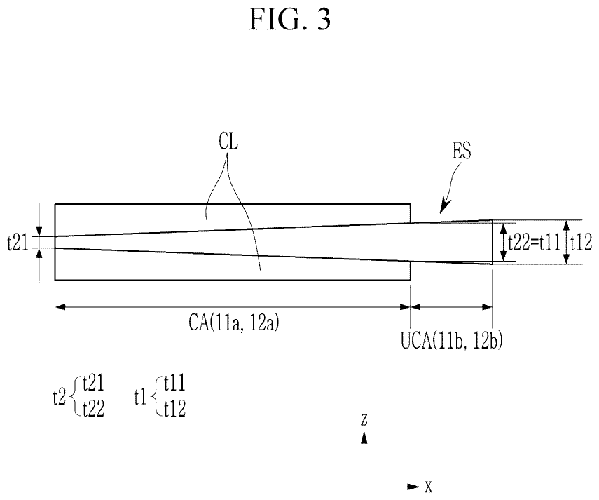

FIG. 2 is a top plan view of an electrode plate applied to FIG. 1, and FIG. 3 is a cross-sectional view taken along the line III-III of FIG. 2. Referring to FIG. 1 to FIG. 3, the negative electrode plate 11 and the positive electrode plate 12 may be formed by applying an active material on each electrode substrate ES.

The electrode substrate ES (e.g., Al and Cu foil) may include a coated area CA (11a, 12a) forming an active material layer CL on both sides, and an uncoated area UCA (11b, 12b) that is exposed without being coated with an active material.

In the jelly-roll state, an uncoated area 11b of the negative electrode plate 11 may be electrically connected to the negative current-collecting plate 11d, and an uncoated area 12b of the positive electrode plate 12 may be electrically connected to the positive current-collecting plate 12d.

Referring back to FIG. 1, the case 20 may form or define an opening on a first side, such that the electrode assembly 10 may be inserted from the outside. The case 20 may be cylindrically formed such that a cylindrical electrode assembly 10 may be accommodated.

The case 20 may be connected to the negative current-collecting plate 11d by welding, and may serve as a negative terminal in the rechargeable battery 1, and may be formed of a conductive metal, such as aluminum, aluminum alloy or nickel-plated steel.

The cap assembly 30 may be electrically insulated from the case 20 by being coupled at the opening of the case 20 with the gasket 50 therebetween, and may close and seal the case 20 that accommodates the electrode assembly 10 and an electrolyte.

The cap assembly 30 may be electrically connected to the electrode assembly 10 through a current-interrupting device and a positive electrode lead tab 40. A positive electrode insulation plate 60 may be interposed between the positive current-collecting plate 12d and the cap assembly 30 to electrically insulate them from each other, and may enable the positive electrode lead tab 40 connected to the positive current-collecting plate 12d to pass through and penetrate toward the cap assembly 30.

The cap assembly 30 may include a cap plate 31, a positive temperature coefficient (PTC) element 35, a vent plate 32, an insulator 33, a middle plate 38, and a sub-plate 34 that are sequentially located from an outer side to an inner side of the case 20.

The cap plate 31 may be finally connected to the positive electrode lead tab 40 to serve as a positive electrode terminal in the rechargeable battery 1, and may form a protruding portion 311 protruding toward an exterior of the case 20, and may form an outlet 312 opened toward a side of the protruding portion 311 to discharge the internal gas.

Substantially, the current-interrupting device in the cap assembly 30 may include the vent plate 32 and the sub-plate 34 that are electrically separated by the insulator 33, and a connection portion partially connecting them. The connection portion may be formed by welding the vent plate 32 and the sub-plate 34.

In one or more embodiments, the vent plate 32 forming a first side of the current-interrupting device may be installed into an inner side of the cap plate 31, and thereby, may be electrically connected to the sub-plate 34 forming a second side of the current-interrupting device.

In one or more embodiments, the vent plate 32 may be provided with a vent 321 at a central portion and welded to the sub-plate 34, and may be separated from the welded sub-plate 34 by an internal pressure. The vent 321 may be broken under a corresponding pressure condition (e.g., predetermined pressure condition) to discharge the internal gas, and to block the electrical connection to the sub-plate 34.

For example, the vent 321 may be formed to protrude from the vent plate 32 toward the inner side of the case 20. The vent plate 32 may be provided with a notch 322 around the vent 321 to guide the breakage of the vent 321.

If the internal pressure of the case 20 increases due to generation of gas, the notch 322 is broken first, and may discharge the gas to the outside through the vent plate 32 and the outlet 312, and may reduce or prevent the likelihood of explosion of the rechargeable battery 1.

The connection between the vent plate 32 and the sub-plate 34 may be broken due to the breakage of the vent 321. The electrode assembly 10 and the cap plate 31 may be electrically separated from each other by the operation of the current-interrupting device.

The positive temperature coefficient element 35 may be installed between the cap plate 31 and the vent plate 32, and may control the current flow between the cap plate 31 and in the vent plate 32 according to an internal temperature of the rechargeable battery 1.

In a state in which the internal temperature exceeds a corresponding temperature (e.g., predetermined temperature), the positive temperature coefficient element 35 may have an electrical resistance that approaches infinite electrical resistance. The positive temperature coefficient element 35 may block the flow of the charge or discharge current between the cap plate 31 and the vent plate 32.

The sub-plate 34 may face the vent plate 32, and may be electrically connected to the vent 321 and the middle plate 38. The middle plate 38 may be spaced apart from the vent plate 32, and may be coupled to the vent plate 32 with the insulator 33 interposed therebetween. In one or more embodiments, the vent 321 may protrude through through-holes 330 and 381 of the insulator 33 and the middle plate 38 to be connected to the sub-plate 34.

The middle plate 38 may be electrically connected to the vent 321 and the vent plate 32 through the sub-plate 34. In one or more embodiments, the middle plate 38 may be connected to the positive electrode lead tab 40 by welding, and the positive electrode lead tab 40 may penetrate the positive electrode insulation plate 60 to be connected to the uncoated area 12b of the positive electrode plate 12 by welding.

Finally, the positive electrode lead tab 40 may sequentially pass through the middle plate 38, the sub-plate 34, the vent 321, the vent plate 32, and the positive temperature coefficient element 35, to be electrically connected to the cap plate 31.

The cap assembly 30 configured as such may be inserted into the opening of the case 20 with the gasket 50 interposed therebetween, and then may be fixed to the opening of the case 20 through a crimping process, and may form the rechargeable battery 1.

The case 20 may form a beading portion 21 on the opening side inserted into or toward a center of the case 20 in a diameter direction, and may form a clamping portion 22 for holding an exterior circumference edge of the cap assembly 30 interposing the gasket 50.

Referring back to FIG. 2 and FIG. 3, a first thickness t1 of the electrode substrate ES in the uncoated area UCA may be greater than a second thickness t2 of the electrode substrate ES in the coated area CA (t1>t2). The uncoated area UCA in the negative electrode plate 11 and the positive electrode plate 12 may be connected to the negative current-collecting plate 11d and to the positive current-collecting plate 12d in the electrode assembly 10 by welding, respectively.

The first thickness t1 of the electrode substrate ES in the uncoated area UCA may be greater than the second thickness t2 of the electrode substrate ES in the coated area CA (t1>t2), and the electrical resistance at end portions of the negative electrode plate 11 and the positive electrode plate 12 may be decreased. In the negative electrode plate 11 and the positive electrode plate 12, the electrochemical non-uniformity may be resolved and the local temperature rise may be decreased.

As an example, the second thickness t2 may have a twenty-first thickness t21 in a width direction (x-axis direction) at a first end of the coated area CA, and may gradually increase toward the uncoated area UCA to have a twenty-second thickness t22 in the width direction (x-axis direction) at a second end of the coated area CA. The active material layer CL may form a maximum thickness at the first end of the coated area CA in the width direction, and may have a thickness that gradually decreases toward the uncoated area UCA.

The first thickness t1 of the electrode substrate ES may have an eleventh thickness t11 of the same magnitude as the twenty-second thickness t22 (t11=t22) at the second end of the coated area CA in the width direction (x-axis direction), and may gradually increase away from the coated area CA to have a twelfth thickness t12 at a first end of the uncoated area UCA in the width direction. The increase of the first thickness t1 may be linearly connected to the increase of the second thickness t2.

In one or more embodiments, the second thickness t2 of the electrode substrate ES in the coated area CA may increase toward a portion connected to the negative current-collecting plate 11d and the positive current-collecting plate 12d, and the first thickness t1 of the uncoated area UCA may increase toward the portion connected to the negative current-collecting plate 11d and the positive current-collecting plate 12d. The electrode substrate ES may have the maximum thickness at the portion connected to the negative current-collecting plate 11d and the positive current-collecting plate 12d, and may have a thickness that decreases away from the negative current-collecting plate 11d and the positive current-collecting plate 12d.

As such, the uncoated area UCA (11b, 12b) in which the electrode substrate ES is formed at the maximum thickness is welded to the negative current-collecting plate 11d and the positive current-collecting plate 12d, and the electrical resistance may be decreased at an end portion of the electrode substrate ES.

As a thickness of the electrode substrate ES decreases, a thickness of the active material layer CL may increase, and the electrode substrate ES of the first one or more embodiments may maintain the energy density. In one or more embodiments, due to the decrease of electrical resistance of the electrode substrate ES due to an increase of thickness, and to the decrease of resistance of the rechargeable battery (cell) 1 caused thereby, fast charging performance, output performance, and lifespan performance may be improved.

The electrode substrate(ES) of the first one or more embodiments is formed of an aluminum (Al) substrate having a linear, inclined connection structure of a thickness, and can be used for positive electrode slurry coating including High-Ni NCA (lithium nickel cobalt aluminum oxide). In this case, in the positive electrode plate 12, the non-uniformity effect due to generated heat may be alleviated.

The electrode substrate ES of the first one or more embodiments may be formed of a copper (Cu) substrate applied with inclination of the thickness, and may be used for the negative electrode slurry coating including Si. In this case, if thin film copper (Cu) is used, the fracture of the negative electrode plate 11 due to expansion of Si may be reduced or prevented.

Hereinafter, various embodiments of the present disclosure will be described. Description for the same configuration as the one or more embodiments described above may be omitted, and different configuration will be focused.

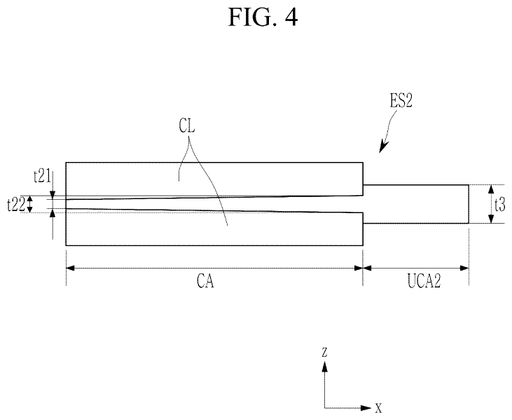

FIG. 4 is a cross-sectional view of an electrode plate applied to a rechargeable battery according to second one or more embodiments of the present disclosure. Referring to FIG. 1 and FIG. 4, the electrode substrate ES2 of the electrode plate applied to a rechargeable battery according to the second one or more embodiments sets a first thickness t3 of the electrode substrate ES2 in an uncoated area UCA2 to be greater than the second thickness t2 of the electrode substrate ES2 in the coated area CA (t3>t2), and the electrical resistance at the end portions of the negative electrode plate 11 and the positive electrode plate 12 may be decreased. In the negative electrode plate 11 and the positive electrode plate 12, the electrochemical non-uniformity may be resolved, and the local temperature rise may be decreased.

As an example, the second thickness t2 may have the twenty-first thickness t21 at the first end of the coated area CA in the width direction (x-axis direction), and may gradually increase toward the uncoated area UCA2 to have the twenty-second thickness t22 at the second end of the coated area CA in the width direction (x-axis direction). The active material layer CL may form a maximum thickness at the first end of the coated area CA in the width direction, and may gradually decrease toward the uncoated area UCA2.

The first thickness t3 of the uncoated area UCA2 may be formed to be greater than the twenty-second thickness t22 at the second end of the coated area CA in the width direction (x-axis direction), and may be the same size across the entire width direction of the uncoated area UCA2. The first thickness t3 may be connected to the second thickness t2 through a stepped line.

In one or more embodiments, the second thickness t2 of the electrode substrate ES2 in the coated area CA may increase from the twenty-first thickness t21 to the twenty-second thickness t22, and toward the portion connected to the negative current-collecting plate 11d and the positive current-collecting plate 12d, and may have the same first thickness t3 in the uncoated area UCA2. The electrode substrate ES2 may have the maximum thickness at the portion connected to the negative current-collecting plate 11d and the positive current-collecting plate 12d.

As such, an uncoated area UCA2 (11b, 12b), in which the electrode substrate ES2 is at the maximum thickness, is welded to the negative current-collecting plate 11d and the positive current-collecting plate 12d, and the electrical resistance may be decreased at an end portion of the electrode substrate ES2.

The electrode substrate ES2 of the second one or more embodiments may be formed as an aluminum (Al) substrate connected through a stepped line of thickness, and may be used for High-Ni NCA positive electrode slurry coating. In this case, in the positive electrode plate 12, the non-uniformity effect due to generation of heat may be alleviated.

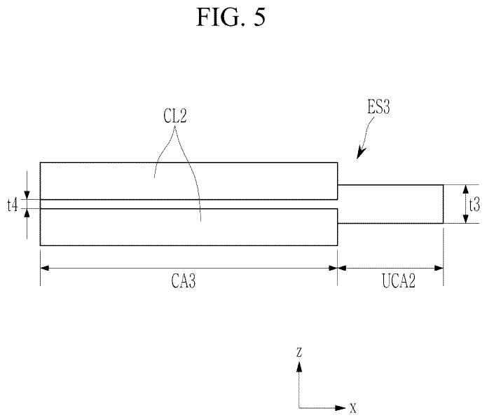

FIG. 5 is a cross-sectional view of an electrode plate applied to a rechargeable battery according to third one or more embodiments of the present disclosure. Referring to FIG. 1 and FIG. 5, the electrode substrate ES3 of the electrode plate applied to a rechargeable battery according to the third one or more embodiments sets the electrode substrate ES3 the first thickness t3 in the uncoated area UCA2 to be greater than a second thickness t4 of the electrode substrate ES3 in the coated area CA3 (t3>t4), and the electrical resistance at the end portions of the negative electrode plate 11 and the positive electrode plate 12 may be decreased. In the negative electrode plate 11 and the positive electrode plate 12, the electrochemical non-uniformity may be resolved, and the local temperature rise may be decreased.

As an example, the second thickness t4 may have the same thickness across the entire width direction (x-axis direction) of the coated area CA3. In one or more embodiments, the active material layer CL may form a same thickness across an entire width direction of the coated area CA3. In one or more embodiments, an active material layer CL2 may have the same thickness across the entire width direction of the coated area CA3.

The first thickness t3 of the uncoated area UCA2 may be the same thickness across the entire width direction (x-axis direction) of the coated area CA3. The first thickness t3 may be connected to the second thickness t4 through a stepped line.

In one or more embodiments, the electrode substrate ES3 may be formed in the first thickness t3 in the portion connected to the negative current-collecting plate 11d and to the positive current-collecting plate 12d, which is greater than the second thickness t4 in the coated area C3. The electrode substrate ES3 may have the maximum thickness at the portion connected to the negative current-collecting plate 11d and to the positive current-collecting plate 12d.

As such, the uncoated area UCA2 (11b, 12b) in which the electrode substrate ES3 is formed at the maximum thickness is welded to the negative current-collecting plate 11d and the positive current-collecting plate 12d, and the electrical resistance may be decreased at an end portion of the electrode substrate ES3.

The electrode substrate ES3 of the third one or more embodiments may be formed as an aluminum (Al) substrate connected through an inclination and stepped line of thickness, and may be used for High-Ni NCA positive electrode slurry coating. In this case, in the positive electrode plate 12, the non-uniformity effect due to generation of heat may be alleviated.

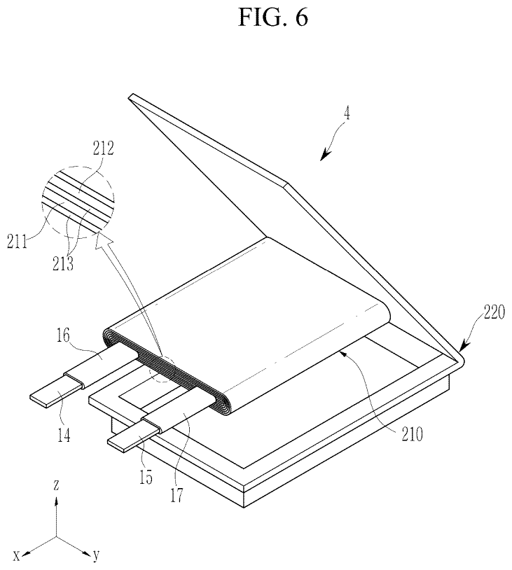

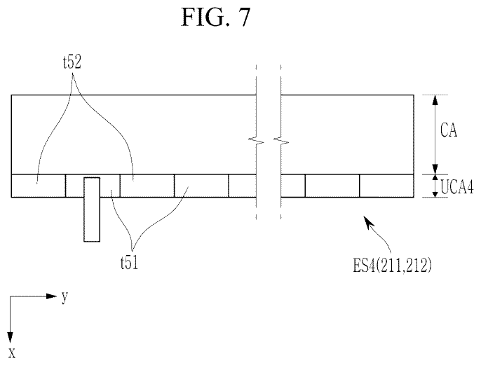

FIG. 6 is an exploded perspective view of a rechargeable battery according to fourth one or more embodiments of the present disclosure, and FIG. 7 is a top plan view of an electrode plate applied to FIG. 6. Referring to FIG. 6 and FIG. 7, a rechargeable battery 4 of the fourth one or more embodiments may include an electrode assembly 210 functioning to charge and discharge the current, and a pouch 220 configured to accommodate the electrode assembly 210 and the electrolyte.

The electrode assembly 210 may be formed to be substantially flat by pressurizing the wound cylindrical shape from side surfaces. The electrode assembly 210 may be connected to a positive electrode plate 211 and a negative electrode plate 212 with a separation layer 213 respectively interposed therebetween, and may be drawn outside the pouch 220 through a first tab 14 and a second tab 15 provided to one side of the wound cross-section. The first tab 14 and the second tab 15 may be located in a sealing portion with insulation tapes 16 and 17 respectively interposed therebetween.

Each of the electrode substrates ES4 forming the positive electrode plate 211 and the negative electrode plate 212 may have the first thickness of the electrode substrate ES4 in the uncoated area UCA and the second thickness of the electrode substrate ES4 in the coated area CA. referring to FIG. 7, the uncoated area UCA of the first thickness may include a thick film portion t51 and a thin film portion t52, which may be alternately formed along a length direction of the uncoated area UCA4. In the electrode substrate ES4 forming the positive electrode plate 211 and the negative electrode plate 212, the first tab 14 and the second tab 15 may be connected to the thick film portion t51 of the uncoated area UCA having a first thickness t5, respectively. The electrode substrate ES4 may have the maximum thickness at a portion

connected to the first tab 14 and the second tab 15. As such, the uncoated area UCA4 in which the electrode substrate ES4 is formed at the maximum thickness is welded to the first tab 14 and the second tab 15, and the electrical resistance may be decreased at an end portion of the electrode substrate ES4.

In the above description, for convenience, it has been described that the rechargeable battery of the first one or more embodiments is cylindrical, that the electrode substrate ES is applied to the cylindrical rechargeable battery, and that the rechargeable battery of the fourth one or more embodiments is pouch-typed and the electrode substrate ES4 is applied to the pouch-type rechargeable battery. However, it may be understood that the electrode substrates ES, ES2, ES3, and ES4 of first to fourth embodiments may be cylindrical, pouch-typed, and/or prismatic rechargeable batteries.

While this disclosure has been described in connection with what is presently considered to be practical embodiments, it is to be understood that the disclosure is not limited to the disclosed embodiments, but is intended to cover various modifications and equivalent arrangements included within the spirit and scope of the appended claims.

### DESCRIPTION OF SYMBOLS

| | |
|---|---|
| 1, 4: rechargeable battery | 10, 210: electrode assembly |
| 11: first electrode plate (negative electrode plate) | |
| 11d: negative current-collecting plate | |
| 12: second electrode plate (positive electrode plate) | |
| 12d: positive current-collecting plate | |
| 13: separation layer | 14: first tab |
| 15: second tab | 20: case |
| 21: beading portion | 22: clamping portion |
| 30: cap assembly | 31: cap plate |
| 32: vent plate | 33: insulator |
| 34: sub-plate | |
| 35: positive temperature coefficient element (PTC) | |
| 38: middle plate | 40: positive electrode lead tab |
| 50: gasket | 60: positive electrode insulation plate |
| 211: positive electrode plate | 212: negative electrode plate |
| 220: pouch | 311: protruding portion |
| 312: outlet | 321: vent |
| 322: notch | CA; 11a, 12a: coated area |
| CA3: coated area | CL: active material layer |
| CL2: active material layer | ES, ES2: electrode substrate |
| ES3, ES4: electrode substrate | t1, t3: first thickness |
| t2, t4: second thickness | t11: eleventh thickness |
| T12: twelfth thickness | t21: twenty-first thickness |
| t22: twenty-second thickness | t51: thick film portion |
| t52: thin film portion | UCA; 11b, 12b: uncoated area |
| UCA2: uncoated area | UCA4: uncoated area |

What is claimed is:

1. A rechargeable battery, comprising:
an electrode assembly comprising a separation layer between a first electrode plate and a second electrode plate comprising an electrode substrate, the electrode substrate comprising:
a coated area with an active material layer, and having a second thickness; and
an uncoated area at a boundary of the coated area in a width direction, and having a first thickness that is greater than the second thickness; and
a case accommodating the electrode assembly.

2. The rechargeable battery as claimed in claim 1, wherein the second thickness of the electrode substrate has a twenty-first thickness at a first end of the coated area in the width direction, and gradually increases toward the uncoated area to have a twenty-second thickness at a second end of the coated area in the width direction.

3. The rechargeable battery as claimed in claim 2, wherein the first thickness has an eleventh thickness equal to the twenty-second thickness at the second end of the coated area, and gradually increases away from the coated area to have a twelfth thickness at a first end of the uncoated area in the width direction.

4. The rechargeable battery as claimed in claim 3, wherein a thickness of the electrode substrate increases linearly from the second thickness to the first thickness.

5. The rechargeable battery as claimed in claim 2, wherein the active material layer has a maximum thickness at the first end of the coated area, and gradually decreases toward the uncoated area.

6. The rechargeable battery as claimed in claim 1, further comprising a current-collecting plate connected to the uncoated area.

7. The rechargeable battery as claimed in claim 2, wherein the first thickness is greater than the twenty-second thickness at the second end of the coated area, and is substantially constant across an entirety of the uncoated area in the width direction.

8. The rechargeable battery as claimed in claim 7, wherein the first thickness transitions to the second thickness through a stepped line.

9. The rechargeable battery as claimed in claim 7, wherein the active material layer has a maximum thickness at the first end of the coated area, and gradually decreases toward the uncoated area.

10. The rechargeable battery as claimed in claim 1, wherein the second thickness is substantially constant across an entirety of the coated area in the width direction.

11. The rechargeable battery as claimed in claim 10, wherein the first thickness is substantially constant across an entirety of the uncoated area in the width direction.

12. The rechargeable battery as claimed in claim 11, wherein the first thickness transitions to the second thickness through a stepped line.

13. The rechargeable battery as claimed in claim 10, wherein the active material layer has a same thickness across an entirety of the coated area in the width direction.

14. The rechargeable battery as claimed in claim 1, wherein the first thickness is substantially constant across an entirety of the uncoated area in a length direction.

15. The rechargeable battery as claimed in claim 1, wherein the uncoated area comprises a thick film portion and a thin film portion alternating along a length direction of the uncoated area.

16. The rechargeable battery as claimed in claim 15, further comprising a tab is connected to the thick film portion.

17. An electrode plate of a rechargeable battery, comprising an electrode substrate comprising:
a coated area having an active material layer, and having a second thickness; and
an uncoated area at an outer boundary of the coated area in a width direction of the electrode substrate, and having a first thickness that is greater than the second thickness.

18. The electrode plate as claimed in claim 17, wherein a thickness of the electrode substrate increases linearly from the second thickness to the first thickness across the width direction.

19. The electrode plate as claimed in claim 17, wherein the second thickness increases linearly across the coated area in the width direction, and
wherein the first thickness transitions to the second thickness through a stepped line, and is substantially constant across an entirety of the uncoated area in the width direction.

20. The electrode plate as claimed in claim 17, wherein the second thickness is substantially constant across an entirety of the coated area in the width direction, and
wherein the first thickness transitions to the coated area through a stepped line, and has a same magnitude across an entirety of the uncoated area in the width direction.
